(19) United States
(12) Patent Application Publication
(10) Pub. No.: US 2004/0093237 A1
(43) Pub. Date: May 13, 2004

(54) Method for conducting and managing community care using an information system

(75) Inventors: Mark M. Redding, Lucas, OH (US); Sarah A. Redding, Lucas, OH (US)

Correspondence Address: James W. McKee, Esq., Fay, Sharpe, Fagan, Minnich & McKee, LLP, 7th Floor, 1100 Superior Avenue, Cleveland, OH, 44114-2518, US

(73) Assignee: COMMUNITY HEALTH ACCESS PROJECT, INC.

(21) Appl. No.: 10/290,707

(22) Filed: Nov. 8, 2002

(51) Int. Cl. G06F 17/60; G06F 7/00; G06F 17/00

(52) U.S. Cl. 705/2; 707/104.1

(57) ABSTRACT

A method is provided for conducting and managing community care using an information system. The method essentially includes the steps of a) identifying a client and establishing a profile in a computerized database; b) identifying a care plan for the client, including health and social problems and pathways to achieve desired outcomes, and recording in the database; c) interacting with the client according to the pathways and recording in the database; d) visiting the client to determine status of problems and progress of pathways and recording in the database; e) assessing the results and, if necessary, revising the care plan; and, in the desired outcomes are achieved, closing the care plan, otherwise scheduling further tasks to accomplish the pathway, recording in the database, and repeating steps c) through f). The information system includes a display device, a computing device having a computerized database, an input device, and a pointing device.

### BACKGROUND OF THE INVENTION

The invention relates to the use of an information system in the community care field. It finds particular application in conjunction with a method for conducting and managing community care and will be described with particular reference thereto. However, it is to be appreciated that the invention is also amenable to use in other applications.

Across the country, coordinated community care is gaining, recognition for its role in building health and social service infrastructures in under-served communities Whether they are known in their communities as community health care advisors, community outreach workers, lay health workers, promoters, guides, or another title, community care coordinators open the door for needed services to reach their clients

Coordinated community care can trace its origin back at least half a century in the United States and even much further back in other countries. Historically, health care and social workers who come from within the communities or villages have provided the most effective intervention for health and social issues. These workers include the Alaskan Community Health Aides and the Central American Promotoras. The Alaska Community Health Aide Program, recognized as the first care coordination model requiring college-level training for its health aides, is credited with reversing, that state's poor social and health statistics. Today, the Health Aide Program has over 500 aides serving, isolated areas.

The community care coordinator is professionally recognized in many states including Arizona, California, Maryland, Massachusetts, Mississippi, and Oregon. On an international scale, the World Health Organization (WHO) is considering the community care coordinator model developed by Arizona's Area Health Education Center (AzAHEC) as a potential international prototype.

A community care coordinator is a trained advocate from the community who empowers individuals to access community resources through education, outreach, home visits, and referrals. The community care coordinator is the foundation of the coordinated community care profession. The community care coordinator assists clients by helping them access needed services quickly. Most importantly, the community care coordinator helps recognize potential serious problems, thus preventing poor health and social outcomes for individuals and communities.

Significant efforts and expenditures have been made to reduce economic and culturally-based disparities in health outcomes. These results and investments have not yet yielded broad-based positive results in the United States.

Traditionally, when there is a defined health or social problem, specialists are brought together to discuss the problem and attempt to find a solution. These specialists may not be aware of or sensitive to the local cultural, community barriers, perceptions or resources. Consideration of these local issues are key in addressing health and social issues.

### BRIEF SUMMARY OF THE INVENTION

Thus, there is a particular need for a new approach to address the above noted disparities and to assure positive outcomes. The invention contemplates a method that helps build positive outcomes in community care in a simple and auditable fashion, referred to as pathways, that overcomes the above-mentioned problems and others. Pathways represent a significant change in approach from that typically utilized in addressing poor health and social outcomes. Though the use of the appropriate pathway, specialists, in collaboration with local community members, can identity any rate-limiting step (barrier), and resources can be specifically directed to that step to generate the desired outcome.

In one aspect of the invention, a method for conducting and managing community care using an information system is advantageously provided. The method includes the steps of a) identifying a resident of a pre-selected community as a client for coordinated community care and establishing a client profile in a computerized care coordination database; b) identifying a care plan for the client, including identifying health and social problems associated with the client and identifying pathways to achieve a desired outcome associated with each problem, and recording the care plan in the database; c) interacting with the client in accordance with individual steps of pathways associated with the client's care plan and recording actions taken in the database, d) visiting the client to determine a status of health and social problems associated with the client and a progress of each pathway in the client's care plan and recording the results of the visit in the database; e) assessing the results of the visit and, if necessary, revising the client's care plan; and, f) if the desired outcome for each of the health and social problems associated with the client has been achieved, closing the client's care plan and exiting the client from coordinated community care, otherwise identifying and scheduling further tasks required to accomplish the remaining individual steps of each associated pathway, recording the schedule for such tasks in the database, and repeating steps c) through f).

According to another aspect of the invention, a method for conducting and managing community care using an information system is provided. The method includes: a) selecting a community in which community care is to be provided; b) employing health care and social worker professionals to perform supervisory and management tasks associated with providing community care to residents of the community, c) employing local individuals from the community to perform community care coordinator tasks associated with providing community care to residents of the community; d) identifying a plurality of health and social problems associated with the community; e) identifying a desired outcome for each problem and a step-by-step pathway to achieving the desired outcome through coordinated community care; f) identifying a resident of the community as a client for coordinated community care and establishing a client profile in a computerized care coordination database; g) interviewing the client to determine health and social problems associated with the client, h) identifying a care plan for the client, including identifying pathways to achieve the associated desired outcomes for the client, and recording the care plan in the database; i) interacting with the client in accordance with individual steps of pathways associated with the client's care plan and recording actions taken in the database; j) visiting the client to determine a status of health and social problems associated with the client and a progress of each pathway in the client's care plan and recording the results of the visit in the database; k) assessing the results of the visit and, if necessary, revising the client's care plan; and, l) if the desired outcome for each of the health and social problems associated with the client have been achieved, closing the client's care plan and exiting the client from coordinated community care, otherwise identifying and scheduling further tasks required to accomplish the remaining individual steps of each associated pathway, recording the schedule for Such tasks in the database, and repeating steps i) through l).

In yet another aspect of the invention, an information system for managing coordinated community care in a computerized database is provided. The information system includes: a display device; a computing device having a computerized database in communication with the display device; an input device with a plurality of control buttons in communication with the computing device; and, a pointing device in communication with the computing device.

Benefits and advantages of the invention will become apparent to those of ordinary skill in the art upon a reading and understanding the description of the invention provided herein.

### BRIEF DESCRIPTION OF THE DRAWINGS

The invention may take form in certain parts and arrangements of parts, preferred embodiments of which will be described in more detail in conjunction with the accompanying drawings which form a part hereof and wherein

FIG. 1 shows one embodiment of a computer system associated with the invention;

FIG. 2 is a block diagram of the computer system shown in FIG. 1,

FIG. 3 is a flowchart of a basic model for an individual pathway associated with the invention;

FIG. 4 is a flowchart of an example of a pregnancy pathway and an exemplary embodiment of an individual pathway associated with the invention,

FIG. 5 is a flowchart of an example of an immunization screening pathway and another exemplary embodiment of an individual pathway associated with the invention,

FIG. 6 is a flowchart of an example of an immunization referral pathway and yet another exemplary embodiment of an individual pathway associated with the invention,

FIG. 7 is a flowchart of an example of the flow of information between a community care coordinator and a supervisor using the care coordination database associated with the invention,

FIG. 8 is a flowchart of an example of the flow of information between a supervisor and a consultant using the care coordination database associated with the invention; and,

FIG. 9 is a flowchart of an example of the flow of information between a supervisor and an external agent using the care coordination database associated with the invention;

### DETAILED DESCRIPTION OF THE INVENTION

While the invention is described in conjunction with the accompanying drawings, the drawings are for purposes of illustrating exemplary embodiments of the invention only and are not to be construed as limiting the invention to such embodiments. It is understood that the invention may take form in various components and arrangement of components and in various steps and arrangement of steps beyond those provided in the drawings and associated description. Within the drawings, like reference numerals denote like elements.

In one embodiment, the invention provides a method for an organization to conduct and manage community care. In one aspect, the method integrates jobs, training, and expanded resources. In another aspect, the method includes community care coordinator training, informational technology, and employment consultation. This serves to incubate and support new programs for community care that can be offered by the organization. The method includes two core elements, namely: 1) a community-based infrastructure and 2) success-based services (also referred to as pathways). New community care programs may expand the community-based infrastructure of the organization geographically or expand the success-based services offered by the organization into new areas of community care. Community care includes various services associated with health care, personal development, and community development.

Community care coordinator training includes training for certification as a professional community care coordinator. Such training may include a 60-hour module in basic competencies, a 76-hour module in a specialized area such as pregnancy and infancy, and a supervised practicum and seminar alternate durations, alternate modules, additional modules, and alternate sequences of modules are also contemplated. Trainees may receive college credits for completing training modules.

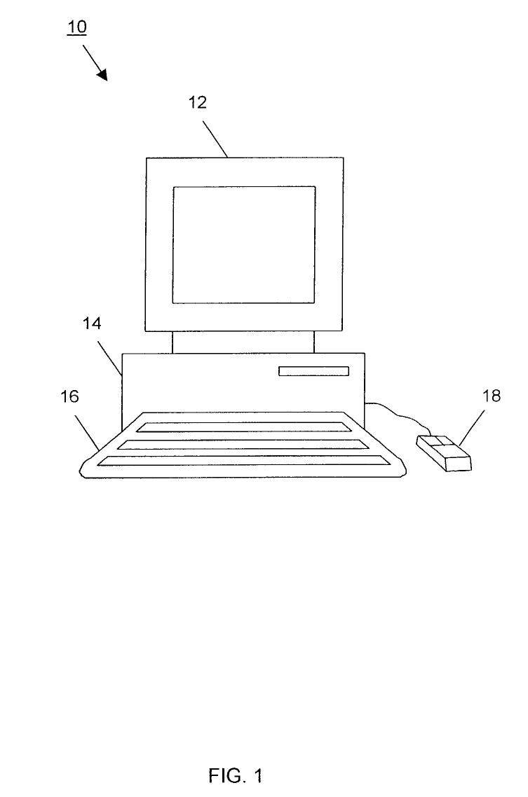

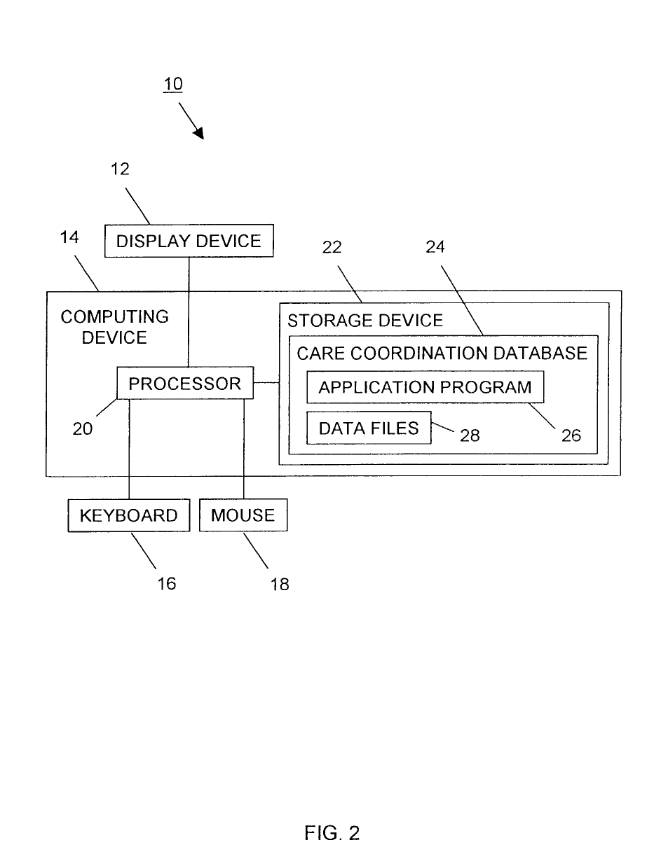

With reference particularly to FIGS. 1 and 2, a computer system 10 provides the information technology associated with one embodiment of the invention. The computer system 10 includes a display device 12, a computing device 14, a keyboard 16, and a mouse 18 The display device 12 may be any type compatible with the computing device 14, including a cathode-ray tube (CRT) display, a liquid crystal display (LCD) matrix display, an alphanumeric display, etc. The computing device 14 includes a processor 20 and a storage device 22. The computing device 14 may comprise a desktop unit or a tower unit associated with a personal computer or computer workstation, or any other type of chassis-type assembly housing the processor 20 and storage device 22. The storage device 22 may include one or more fixed storage devices, one or more storage devices with removable media, or combinations of one or more fixed storage devices and one or more storage devices with removable media. The keyboard 16 may be a QWERTY keyboard or any type of input device compatible with the computing device 14. The mouse 18 may be any type of mouse or pointing device, including a trackball, glidepad, touch screen, etc.

The computer system 10 includes a care coordination database 24 that provides the ability to electronically document, share, and case-manage all information related to community care clients in a secure format respecting patient confidentiality. A goal of the care coordination database 24 is to overcome information related barriers to health and social services. The care coordination database 24 includes an application program 26 and data files 28. The application program 26 may be a relational database management software application tailored to the specific functions required for coordinated community care or any type of application program capable of storing, and retrieving, the information associated with coordinated community care in tie associated data files 28. Each pathway is individually tracked and recorded with timelines for each step. When each pathway is completed it archived and removed from the active client pathways.

The care coordination database 24: 1) allows changes in data collection without reprogramming, 2) provides data forms that automatically include basic demographic information attached to “yes -- no” checklists and comments/questions specific to each project, 3) requires minimal computer skills training (forms can also be filled out on a hand-held PC or laptop), 4) allows quick access for case managers to review information, to respond with action plans and completion dates, and to track results with complete archiving of the action and result, 5) secures information cued to specified persons participating in the case management process, 6) produces an automatically formatted final progress note that includes assessment, recommended actions and other relevant client data, 7) achieves complete electronic charting and 8) links data elements for the creation of reports that can cover any given time range (i e, billing, quality improvement, and productivity all become standard and easy to activate).

In alternate configurations, multiple computer systems may be interconnected in a computer network. The computer network may also be configured in a client-server arrangement with respect to the care coordination database 24.

Employment consultation includes establishing and regulating organizational policies and procedures, establishing employee goals and incentives, monitoring and reporting employee performance and productivity, and various other forms of quality assurance The method provides techniques for hiring and development of members of communities with the greatest health and social needs as community care coordinators.

The method uses geomapping to identify specific areas or neighborhoods within targeted communities that have a history of poor health and social outcomes. The community care program then focuses on the specific neighborhood selected to identify local leaders to help guide the efforts of the community care organization, as well as individuals who are connected to the community and who can potentially serve as employees. Local individuals are recruited and screened and, if qualified, hired and trained to serve their community neighbors as a connection to locally available health and social services offered by the organization. These advocates are called community care coordinators. The community care coordinators assist with making appointments for needed health and social services, transportation, basic health education, literacy, education, and job placement. Maternal child health is often a specific focus of the method, but issues across all stages of life may also be effectively served.

Individual and family health and social needs data are collected and documented during an initial home visit by the community care coordinators. Specifically designed forms are used for the health and social issues of the selected community. The data collected is evaluated by a supervisor with advanced training in social work, nursing, or other related fields. The care coordination database 24 serves as an electronic chart allowing the data to be entered, then case-managed through the generated client assessment and specific action plan developed for the individual client or family. The plan is developed based upon the needs of the client. This plan includes specific outcome-based groups of steps that define the needs (problem) and provide for documentation of resolution(s). The plan of outcome-based steps may be referred to as a pathway Success for the client is dependent upon overcoming the barriers and issues identified by the community care coordinators, followed by an accurate evaluation of the needs by the supervisor who assigns the pathway(s). The pathway-based plan is carried out by the community care coordinators with a focus on successful outcomes

In one embodiment of the invention, approximately 50 basic outcomes are identified upon which the method is implemented. Typically, a team of health and social service experts, in conjunction with community representatives, then identify all the basic steps related to the successful generation of these outcomes.

The pathway steps are designed to provide for flexibility. Therefore, as client and community needs become more clearly identified, the steps are developed into a more specific format that can be utilized by all outreach workers, i.e., community care coordinators or those representing other programs/services, providing a consistent approach toward successful outcomes. A pathway provides the basic approach to meet the specific needs of the client and, if followed, leads to successful problem resolution. Pathways take into account the potential for lack of phones, transportation, communication skills, and the level of trust required between the community care coordinator and the client. Any missed step in the pathway process may lead to delays or lack of successful resolution (outcome production). Many public health programs do not take into account intangible barriers in approaching interventions or solutions. Through pathways, barriers can be isolated, evaluated for their importance and resolved. Interventions proven to overcome rate-limiting steps can be implemented and changes in outcomes can be monitored.

Every client has at least one basic goal or outcome that is identified through the interview process. For example, the goal or desired outcome is housing for a homeless client; a healthy baby for a pregnant client; and updated immunizations for a needy child. Focusing on each client's desired outcome, pathways provides a step-by-step guide to move the client from the basic health or social need to the solution. Thus, pathways drive the care coordination process toward achieving successful outcomes for the client. The use of pathways standardizes organizational procedures and the expected actions of the community care coordinators.

The key to pathways is the focus on a defined approach to client success. Each client has a problem list developed which leads to an overall assessment and plan of action that includes all applicable pathways. Individual pathways can span differing time periods but provide the basic process and required steps for addressing any identified client issue. Similar to clinical practice guidelines, an applicable pathway outlines the best course of action. Pathways are developed based upon the study of best practices in coordinated community care.

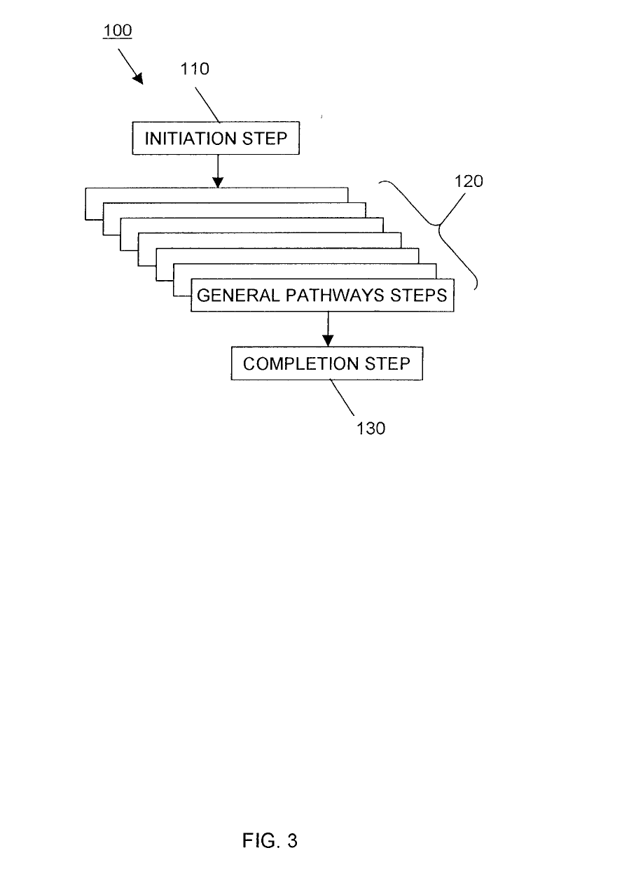

With reference to FIG. 3, the pathways model 100 includes three basic steps 1) an initiation step 110, 2) a set of general pathway steps 120, and 3) a completion step 130. Each pathway 100 typically begins with the initiation step 110. The initiation step 110 must clearly define a problem for which a focus and identified outcome have been identified with respect to health care for a targeted community. For example, a child is found to be living in a home at-risk for exposure to lead paint. This step may be confirmed by the supervisor before the community care coordinator receives credit for completion of the initiation step. Note that the method may include a system that provides financial incentives for community care coordinators to accomplish outcomes/pathways. The steps following initiation are carried out by the community care coordinator. If the general pathway steps 120 exceed more than seven basic steps, another pathway 100 is usually developed. The completion step 130 must be a clearly defined and desirable outcome. This step is typically confirmed by the supervisor. The completion step 130 is the end product of the pathway model 100. In relation to the above example, the child must now be living in a home safe from risks of exposure to lead paint and must have completed all medical follow-up examinations and evaluations

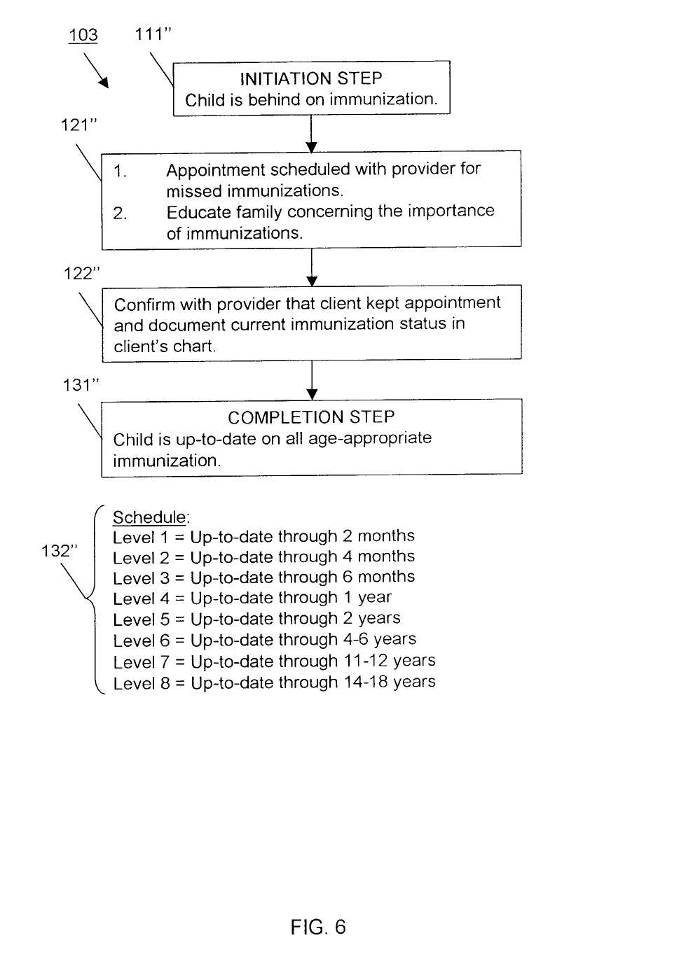

The care coordination database 24 is utilized for the initiation and monitoring of pathway completion. When a specific pathway 100 is confirmed, community care coordinators are provided with an expected date of completion and each step of the pathway 100 is monitored for progress. Reports may be generated to measure the progress and status of one or more individual pathways, pathways associated with one or more individual community care coordinators, or pathways associated with the overall organization, including time lines for final outcome (production) as well as step-to-step progress. For example, an immunization pathway (FIG. 6) provides measurement of the time required to get an appointment for the client as well as recording that immunizations are up to date (outcome achieved). In some cases, discussions with cooperating agencies can lead to reducing the time between steps and expediting pathway completion (outcome production).

Pathways place significant emphasis on completion (outcome production) and less emphasis on specific activities, which may or may not be related to outcomes. For example, current community care programs are usually based on the number of clients served and the number of home visits by the community care coordinators. These activities were at first evaluated as being relevant to outcomes, but community care coordinators were observed to be seeing large numbers of clients who had no significant issues for which outcomes could be changed The pathways process provides the opportunity to move beyond those clients without issues to focus on clients with significant problems.

The ultimate successful outcome for a completed pathways process is home stabilization, health, education and employment with the client self sufficient and exited from the system. The approach of the pathways brings several benefits to community care programs, namely: 1) clear, standardized guidelines, 2) easy tracking of completed outcomes, and 3) reportable action or service by steps Pathways 100 can be used within agencies and, with collaboration, across communities to assist in successfully dealing with many specific issues. By being reviewed and revised according to changes in best practices, pathways 100 create the best standard approach possible with broad community collaboration.

Appropriate definition of the initiation step (problem identification) 110, the specific pathway steps 120, and the completion step (resolution of the problem) 130 are critical and require compliance with defined protocols and the involvement of appropriate professionals and culturally connected community representatives.

Work activities, client management and quality assurance are completely focused under the pathways approach. Typical completed pathway outcomes include preventive service outcomes such as confirmed compliance with prenatal care, educational outcomes, and employment.

Implementation of the pathways model leads to development of a community-based outreach agency that ties together the community infrastructure and the process of providing basic health and social services. Through pathways 100, positive outcomes in health, education and employment can be demonstrated, for example, in culturally diverse communities.

Economically disadvantaged and culturally isolated individuals often do not have transportation, phones, appointment-making skills or a basic level of trust and comfort with the medical or social services needed. Including these issues as key steps in the pathways process can significantly improve the health and overall strength of the community and, at the same time, save significant resources through prevention of catastrophic outcomes. Barriers can be successfully overcome and positive outcomes can be reached through effective focus and attention on developing and following the proper steps of the pathway.

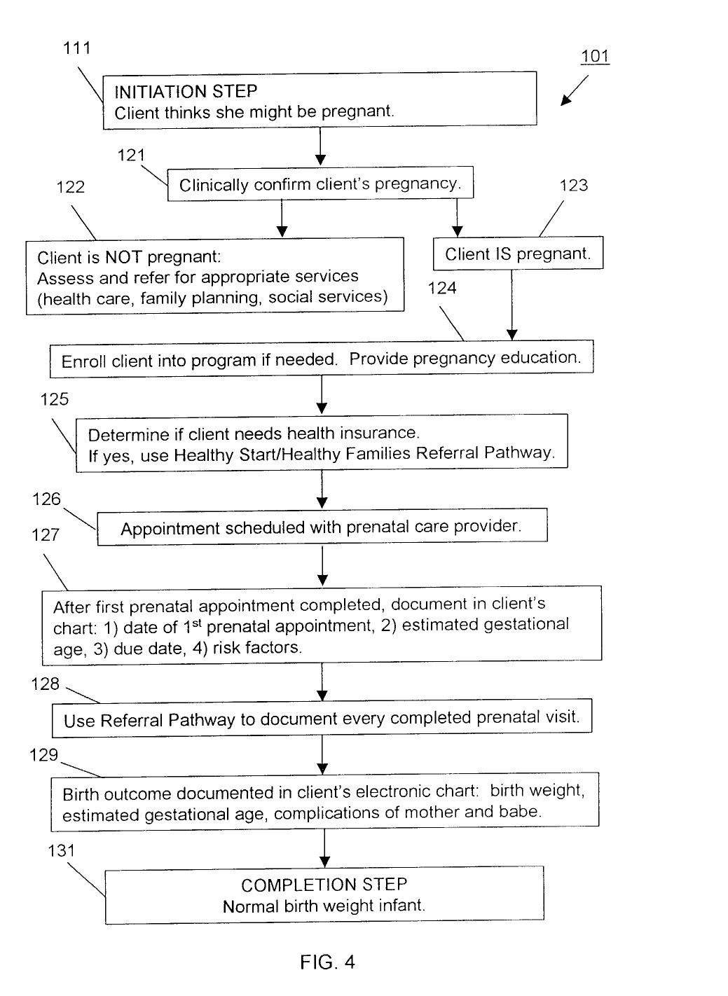

With reference to FIG. 4, an example of a pregnancy pathway 101 is provided as an exemplary embodiment of an individual pathway. There, in the initiation step 111, a client thinks she might be pregnant. Next, in step 121, the client's pregnancy is clinically confirmed. If the client is not pregnant, at step 122, the client is assessed and referred for appropriate services (e.g., health care, family planning, social services) If the client is pregnant, at step 123, the pregnancy pathway 101 continues.

At step 124, if needed, the client is enrolled in a program to provide pregnancy education. Next, at step 125, a determination is made as to whether the client needs health insurance. If health insurance is needed, another pathway is used (e.g., healthy start/healthy families referral pathway) to ensure the client is properly covered by a health insurance provider. At step 126, the pathway continues by scheduling an appointment with a prenatal care provider. After the first prenatal appointment is completed, at step 127, the date of the first prenatal appointment, estimated gestational age, due date, and risk factors are documented in the client's chart. Next, at step 128, another pathway (e g referral pathway) is used to document every completed prenatal visit by the client to the prenatal care provider. At step 129, the birth outcome is documented in the client's electronic chart. This includes the birth weight, estimated gestational age, and complications of mother and babe. The completion step 131 is achieved when the client gives birth to a normal birth weight infant.

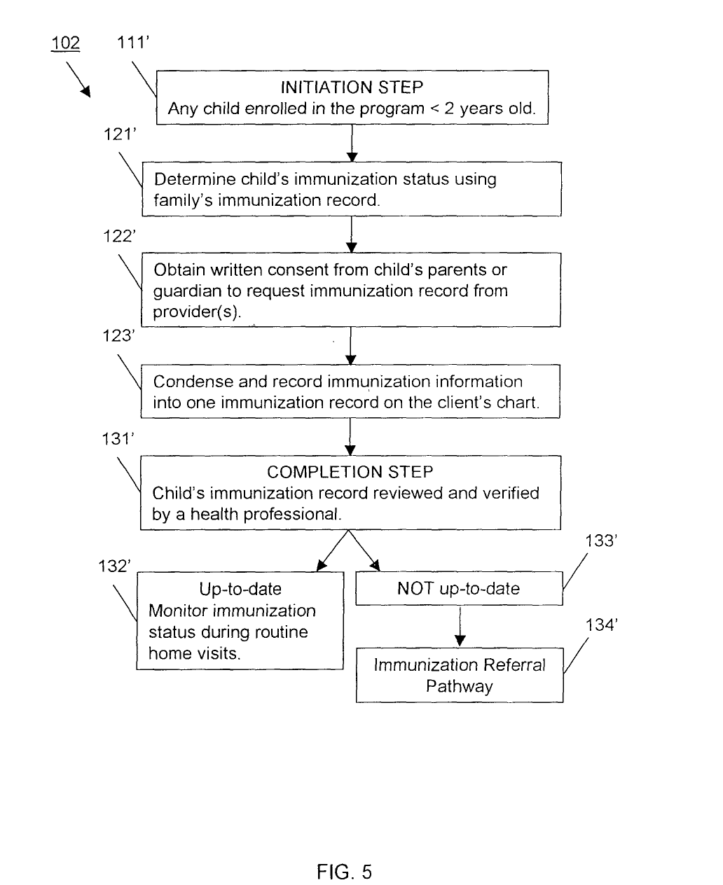

With reference to FIG. 5, an example of an immunization screening pathway 102 is provided as another exemplary embodiment of an individual pathway. As shown, in the initiation step 111, any child enrolled in the program less than two years old is identified. Next, in step 121′, the community care coordinator determines the child's immunization status using the family's immunization record At step 122′, the community care coordinator obtains written consent from the child's parent or guardian to request immunization records from the child's health care providers In step 123′, the immunization information is condensed and recorded into one immunization record on the client′s chart.

In the completion step 131′, a supervisor (health professional) reviews and verities the child's immunization record. If the child's immunization status is up-to-date as at 132′, the community care coordinator monitors the child's immunization status during routine home visits. Conversely, if the child's immunization status is not up-to-date as at 133′, the immunization referral pathway 134′ is added to the client's chart and the child's care plan.

FIG. 6 provides an example of the immunization referral pathway 103 as yet another exemplary embodiment of an individual pathway. As shown, a child that is behind on immunization is identified in the initiation step 111″. Next, in step 121″, the community care coordinator schedules an appointment with a health care provider for the immunizations that the child has missed. Additionally, the community care coordinator educates the family concerning the importance of immunizations. At step 122″, the community care coordinator confirms with the health care provider that the client kept the appointment, and then updates the current immunization status in the client's chart

At the completion step 131″, the child is up-to-date on all age-appropriate immunizations. Note that the immunization screening pathway 102 and the immunization referral pathway 103 are integrated to ensure that the child's immunization status is up-to-date for a predetermined period of the child's life (e g., through eighteen years of age). An example schedule for immunization screening and referral 132″ may include eight levels or iterations of screening and referral. As shown in FIG. 6, completion of Level 1 may indicate that the child is up-to-date on all immunizations through 2 months of age. Completion of Level 2 may indicate that the child is up-to-date on all immunizations through 4 months of age Completion of Level 3 may indicate that the child is up-to-date on all immunizations through 6 months of age. Completion of Level 4 may indicate that the child is up-to-date on all immunizations though 1 year of age. Completion of Level 5 may indicate that the child is up-to-date on all immunizations through 2 years of age. Completion of Level 6 may indicate that the child is up-to-date on all immunizations through 4-6 years of age. Completion of Level 7 may indicate that the child is up-to-date on all immunizations through 11-12 years of age. Finally, completion of Level 8 may indicate that the child is up-to-date on all immunizations through 14-18 years of age.

The care coordination database 24 acts as the repository for client information from the client's initial enrollment through completion of all pathways associated with the client's care plan. The care coordination database 24 includes an application program 26 for entering, editing, and retrieving the client information and data files 28 for storing the client information. The application program 26 may require user login sequence where a user enters a user name and an associated password to gain access to the care coordination database 24.

A user enters a profile for a new client using the application program 26. Then, visit information for the new client can be entered. The results of an initial visit and each follow-up visit are entered after visits with the client. Visit results may include checklists with comments and qualifiers, progress notes, and vital information. The visit results are saved in data files 28 and cued to a supervisor's mailbox. Changes to the visit results, other than adding progress notes, cannot be made until the supervisor has reviewed the information and updated the client's record. The supervisor assesses the visit results and decides which pathways and/or actions are appropriate. The supervisor then cues the tasks (i.e., pathways and/or actions) to be accomplished back to the community care coordinator's mailbox. If no further tasks are required, the supervisor closes the visit, and a visit closure notification is cued to the community care coordinator's mailbox

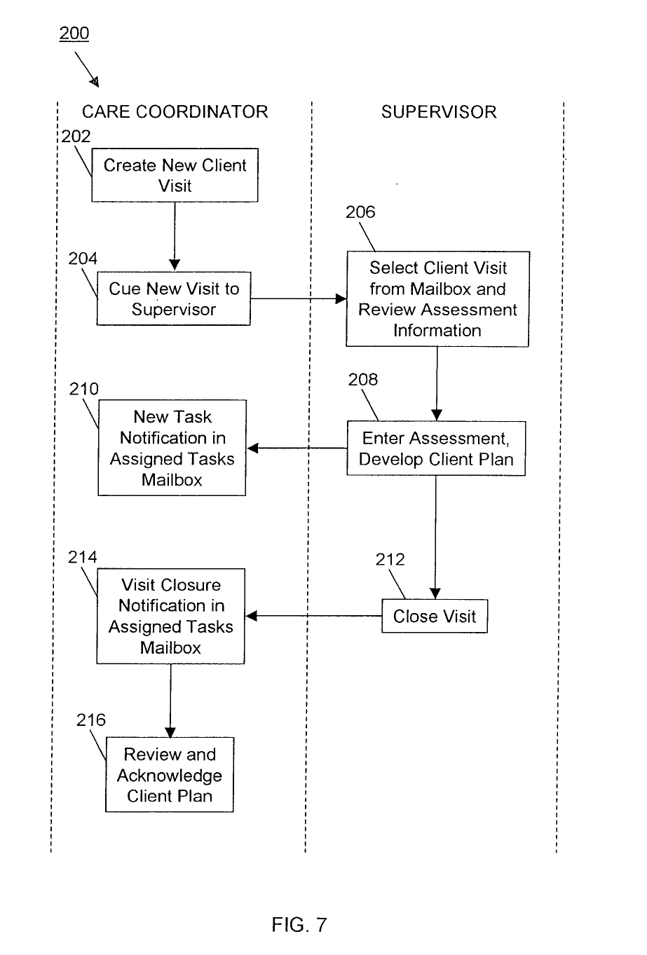

An example of the flow of information between a community care coordinator and a supervisor 200 using the care coordination database 24 is provided in FIG. 7. Tasks accomplished by the community care coordinator are shown along the left side of the diagram, while tasks accomplished by the supervisor are shown along the right side. At step 202, client information is created by the community care coordinator when a record of a new client visit in the care coordination database is created. Next, in step 204, the community care coordinator cues the new client visit information to a supervisor's mailbox.

At step 206, the supervisor selects the new client visit information from the mailbox and reviews the community care coordinator's record of the visit. Next, in step 208, the supervisor assesses the results of the visit and develops or revises the client plan accordingly. If additional tasks are required, the supervisor cues the tasks to be accomplished to the community care coordinator's mailbox. At step 210, the community care coordinator selects the task notification from the mailbox and continues according to the client plan. If no further tasks are required, the supervisor closes the client visit at step 212 and cues a visit closure notification to the community care coordinator's mailbox.

At step 214, the community care coordinator selects the visit closure notification from the mailbox. Next, in step 216 the community care coordinator reviews and acknowledges the client plan.

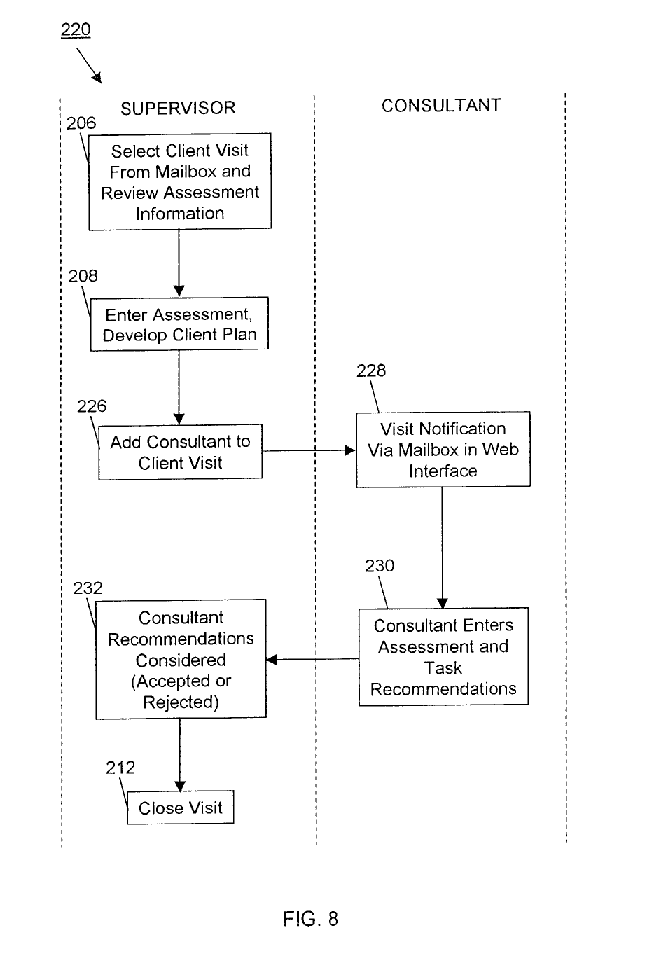

FIG. 8 provides a diagram illustrating the flow of information between a supervisor and a consultant 220 using the care coordination database 24. As in FIG. 7, at step 206, the supervisor selects the new client visit information from his or her mailbox and reviews the community care coordinator's record of the visit. In step 208, the supervisor next assesses the results of the visit and develops or revises the client plan accordingly. If the supervisor concludes that the opinion or recommendations of a consultant are necessary, the supervisor cues the new client visit information to a consultant's mailbox. The consultant's mailbox may be accessible via any type of computer network, including a local area network, intranet, internet, or via the Internet.

At step 228, the consultant selects the new client visit information fiom his or her mailbox and reviews the community care coordinator's record visit. Next, in step 230, the consultant assesses the results of the visit and provides recommendations on whether to develop or revise the client plan accordingly. The consultant cues the recommendations to the supervisor's mailbox. At step 232, the supervisor selects the recommendations from the mailbox and determines whether to accept or reject them in whole or in part. If no further tasks are required, the supervisor closes the client visit at step 212 and cues a visit closure notification to the community care coordinator's mailbox. Conversely, if additional tasks are required, the supervisor cues the tasks to be accomplished to the community care coordinator's mailbox, and interactions between the community care coordinator and supervisor continue as in FIG. 7.

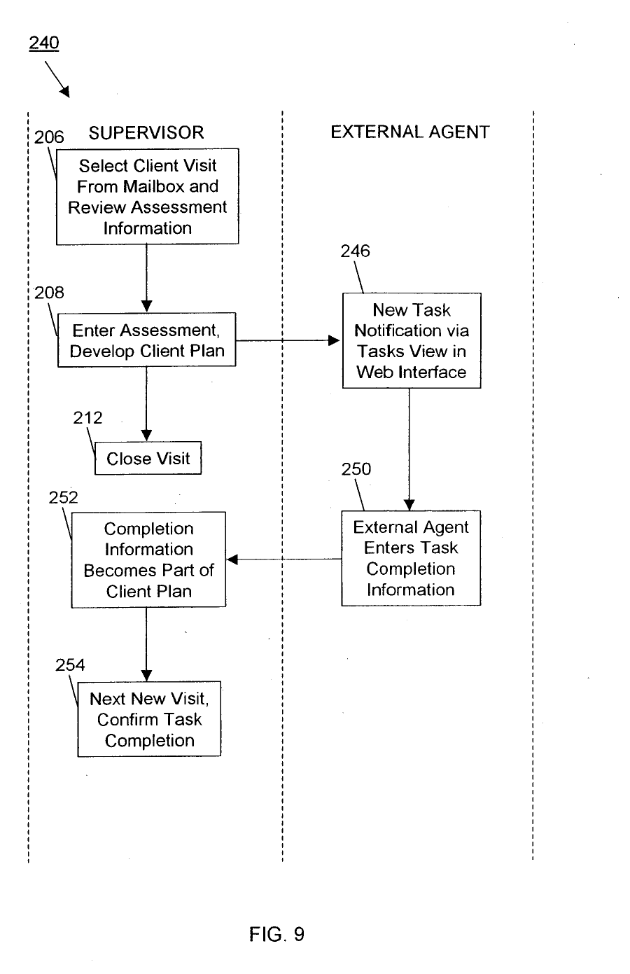

A diagram illustrating the flow of information between a supervisor and an external agent 240 using the care coordination database 24 is provided in FIG. 9. As in FIG. 7, at step 206, the supervisor selects the new client visit information from his or her mailbox and reviews the community care coordinator's record of the visit. Next, the supervisor assesses the results of the visit at step 208 and develops or revises the client plan accordingly. If no further tasks are required, the supervisor closes the client visit at step 212 and cues a visit closure notification to the community care coordinator's mailbox.

If additional tasks are required and the supervisor concludes that an external agent is needed to supplement the tasks accomplished by the community care coordinator, the supervisor cues the tasks to be accomplished to the external agent's mailbox. At step 246, the external agent selects the task notification from his or her mailbox and continues according to the client plan. Next, at step 250, the external agent enters task completion information and cues the results to the supervisor's mailbox. In step 252, the supervisor adds the task completion information from the external agent to the client plan. Then, at step 254, the supervisor identifies a new client visit for the community care coordinator to confirm task completion.

While the invention is described herein in conjunction with exemplary embodiments, it is evident that many alternatives, modifications, and variations will be apparent to those skilled in the art Accordingly, the embodiments of the invention in the preceding description are intended to be illustrative, rather than limiting, of the spirit and scope of the invention. More specifically, it is intended that the invention embrace all alternatives, modifications, and variations of the exemplary embodiments described herein that fall within the spirit and scope of the appended claims or the equivalents thereof

What is claimed is:

1. A method for conducting and managing community care using an information system, the method comprising the following steps:
a) identifying a resident of a preselected community as a client for coordinated community care and establishing a client profile in a computerized care coordination database,
b) identifying a care plan for the client, including identifying health and social problems associated with the client and identifying pathways to achieve a desired outcome associated with each problem, and recording the care plan in the database;
c) interacting with the client in accordance with individual steps of pathways associated with the client's care plan and recording actions taken in the database,
d) visiting the client to determine a status of health and social problems associated with the client and a progress of each pathway in the client's care plan and recording the results of the visit in the database;
e) assessing the results of the visit and, if necessary, revising the client's care plan, and,
f) if the desired outcome for each of the health and social problems associated with the client have been achieved, closing the client's care plan and exiting the client from coordinated community care, otherwise identifying and scheduling further tasks required to accomplish the remaining individual steps of each associated pathway, recording the schedule for such tasks in the database, and repeating steps c) through f).

2. The method of claim 1, wherein step b) is accomplished by one of a health care and social worker professional employed to perform supervisory and management tasks associated with providing community care to residents of the community.

3. The method of claim 1, wherein step c) is accomplished by a local individual from the community employed to perform community care coordinator tasks associated with providing community care to residents of the community.

4. The method of claim 1, wherein step c) is accomplished by an external agent contracted to perform community care coordinator tasks associated with providing community care to residents of the community.

5. The method of claim 1, wherein step d) is accomplished by a local individual from the community employed to perform community care coordinator tasks associated with providing community care to residents of the community.

6. The method of claim 1, wherein step d) is accomplished by an external agent contracted to perform community care coordinator tasks associated with providing community care to residents of the community.

7. The method of claim 1, wherein step e) is accomplished by one of a health care and social worker professional employed to performing supervisory and management tasks associated with providing community care to residents of the community.

8. The method of claim 1, wherein step e) is accomplished by a consultant contracted to perform supervisory and management tasks associated with providing community care to residents of the community.

9. The method of claim 1, wherein step f) is accomplished by one of a health care or social worker professional employed to perform supervisory and management tasks associated with providing community care to residents of the community.

10. The method of claim 1, wherein step f) is accomplished by a consultant contracted to perform supervisory and management tasks associated with providing community care to residents of the community.

11. The method of claim 1, further comprising the following steps
g) identifying a plurality of health and social problems associated with the community; and
h) identifying a desired outcome for each problem and a step-by-step pathway to achieving the desired outcome through coordinated community care.

12. A method for conducting and managing community care using an information system, the method comprising the following steps:
a) selecting a community in which community care is to be provided;
b) employing health care and social worker professionals to perform supervisory and management tasks associated with providing community care to residents of the community,
c) employing local individuals from the community to perform community care coordinator tasks associated with providing community care to residents of the community;
d) identifying a plurality of health and social problems associated with the community;
e) identifying a desired outcome for each problem and a step-by-step pathway to achieving the desired outcome through coordinated community care,
f) identifying a resident of the community as a client for coordinated community care and establishing a client profile in a computerized care coordination database,
g) interviewing the client to determine health and social problems associated with the client;
h) identifying a care plan for the client, including identifying pathways to achieve the associated desired outcomes for the client, and recording the care plan in the database,
i) interacting with the client in accordance with individual steps of pathways associated with the client's care plan and recording actions taken in the database;
j) visiting the client to determine a status of health and social problems associated with the client and a progress of each pathway in the client's care plan and recording the results of the visit in the database;
k) assessing the results of the visit and, if necessary, revising the client's care plan; and,
i) if the desired outcome for each of the health and social problems associated with the client have been achieved, closing the client's care plan and exiting the client from coordinated community care, otherwise identifying and scheduling further tasks required to accomplish the remaining individual steps of each associated pathway, recording the schedule for such tasks in the database, and repeating steps i) through 1).

13. The method of claim 12, wherein steps i) and j) are accomplished by an external agent contracted to perform community care coordinator tasks associated with providing community care to residents of the community.

14. The method of claim 12, wherein step k) is accomplished by a consultant contracted to perform supervisory and management tasks associated with providing community care to residents of the community.

15. An information system for managing coordinated community care in a computerized database, the system comprising:
a display device;
a computing device having a computerized database in communication with the display device,
an input device with a plurality of control buttons in communication with the computing device; and
a pointing device in communication with the computing device.

16. The information system of claim 15, the computing device further comprising:
a processor in communication with the display device, input device, and pointing device; and
a storage device with the computerized database in communication with the processor.

17. The information system of claim 16, wherein the storage device is a fixed storage device.

18. The information system of claim 16, wherein the storage device comprises a storage device that is compatible with removable media.

19. The information system of claim 16, wherein the computerized database care coordination database.

20. The information system of claim 19, the care coordination database further including:
application program for entering and retrieving client information associated with coordinated community care in the computerized database; and,
a set of data files for storing the client information.
